(19) United States
(12) Patent Application Publication
(10) Pub. No.: US 2018/0202265 A1
(43) Pub. Date: Jul. 19, 2018

(54) Method And Workflow For Accurate Modeling Of Near-Field Formation In Wellbore Simulations

(71) Applicant: LANDMARK GRAPHICS CORPORATION, Houston, TX (US)

(72) Inventors: Andrey Filippov, Houston, TX (US); Jianxin Lu, Bellaire, TX (US); Vitaly Khoriakov, Calgary (CA); Xinli Jia, Sugar Land, TX (US)

(21) Appl. No.: 15/741,955

(22) PCT Filed: Aug. 21, 2015
(86) PCT No.: PCT/US2015/046398

§ 371 Date: Jan. 4, 2018

(51) Int. Cl. E21B 41/00; G06F 17/50; E21B 47/06; E21B 47/10

(52) U.S. Cl. CPC E21B 41/0092; G06F 17/5009; E21B 47/06; E21B 43/2406; E21B 47/10; G06F 2217/16; E21B 47/065

(57) ABSTRACT

Methods and systems are presented in this disclosure for accurate modeling of near-field formation in wellbore simulations. The approach presented herein is based on splitting a transient three-dimensional solution of finding heat and mass transfer parameters in a wellbore and a near-wellbore region into coupling modeling of a flow inside the wellbore with several transient two-dimensional solutions in the vicinity to the wellbore.

### TECHNICAL FIELD

The present disclosure generally relates to wellbore simulations and, more particularly, to a method and workflow for accurate modeling of near-field formation in wellbore simulations.

### BACKGROUND

Simulation of reservoirs and wellbores represent an area of reservoir and wellbore engineering that employs computer models to predict the transport of fluids, such as oil, water, and gas, within a reservoir and a wellbore. Reservoir and wellbore simulators typically employ three-dimensional (3D) computer models that take into account full or at least partial scale of a reservoir formation and a wellbore.

In a variety of completion production design simulations, the local near-wellbore length scale often does not justify the application of typical full-scale 3D reservoir simulators, or even medium-scale reservoir simulators. Meanwhile, due to a high aspect ratio of the wellbore/reservoir system, the heat and mass transfer processes in reservoirs and wellbores are often two-dimensional (2D).

Accordingly, it is desirable to improve functionality of wellbore and reservoir formation simulators.

### BRIEF DESCRIPTION OF THE DRAWINGS

Various embodiments of the present disclosure will be understood more fully from the detailed description given below and from the accompanying drawings of various embodiments of the disclosure. In the drawings, like reference numbers may indicate identical or functionally similar elements.

FIG. 1 is a view of modeling a flow inside a wellbore by solving simulation in the near-wellbore domain either as a sequence of two-dimensional (2D) applications or a three-dimensional (3D) application in a narrow volume next to the wellbore, according to certain embodiments of the present disclosure.

FIG. 2 is a flowchart of a coupled wellbore-reservoir simulation, according to certain embodiments of the present disclosure.

FIG. 3 is an example view of simulation scheme for a steam assisted gravity drainage (SAGD) process, according to certain embodiments of the present disclosure.

FIG. 4 is an example view of a steam flooding pattern of injector wells and producer wells, according to certain embodiments of the present disclosure.

FIG. 5 is a schematic model of production from a fracture-stimulated reservoir, according to certain embodiments of the present disclosure.

FIG. 6 is a schematic view of gas and water coning, according to certain embodiments of the present disclosure.

FIG. 7 is a flow chart of a method for modeling near-field formation in wellbore simulations, according to certain embodiments of the present disclosure.

FIG. 8 is a block diagram of an illustrative computer system in which embodiments of the present disclosure may be implemented.

### DETAILED DESCRIPTION

Embodiments of the present disclosure relate to a method and workflow for accurate modeling of near-field formation in wellbore simulations. While the present disclosure is described herein with reference to illustrative embodiments for particular applications, it should be understood that embodiments are not limited thereto. Other embodiments are possible, and modifications can be made to the embodiments within the spirit and scope of the teachings herein and additional fields in which the embodiments would be of significant utility.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described. It would also be apparent to one skilled in the relevant art that the embodiments, as described herein, can be implemented in many different embodiments of software, hardware, firmware, and/or the entities illustrated in the figures. Any actual software code with the specialized control of hardware to implement embodiments is not limiting of the detailed description. Thus, the operational behavior of embodiments will be described with the understanding that modifications and variations of the embodiments are possible, given the level of detail presented herein.

The disclosure may repeat reference numerals and/or letters in the various examples or Figures. This repetition is for the purpose of simplicity and clarity and does not in itself dictate a relationship between the various embodiments and/or configurations discussed. Further, spatially relative terms, such as beneath, below, lower, above, upper, uphole, downhole, upstream, downstream, and the like, may be used herein for ease of description to describe one element or feature's relationship to another element(s) or feature(s) as illustrated, the upward direction being toward the top of the corresponding figure and the downward direction being toward the bottom of the corresponding figure, the uphole direction being toward the surface of the wellbore, the downhole direction being toward the toe of the wellbore. Unless otherwise stated, the spatially relative terms are intended to encompass different orientations of the apparatus in use or operation in addition to the orientation depicted in the Figures. For example, if an apparatus in the Figures is turned over, elements described as being “below” or “beneath” other elements or features would then be oriented “above” the other elements or features. Thus, the exemplary term “below” can encompass both an orientation of above and below. The apparatus may be otherwise oriented (rotated 90 degrees or at other orientations) and the spatially relative descriptors used herein may likewise be interpreted accordingly.

Moreover even though a Figure may depict a horizontal wellbore or a vertical wellbore, unless indicated otherwise, it should be understood by those skilled in the art that the apparatus according to the present disclosure is equally well suited for use in wellbores having other orientations including vertical wellbores, slanted wellbores, multilateral wellbores or the like. Likewise, unless otherwise noted, even though a Figure may depict an offshore operation, it should be understood by those skilled in the art that the apparatus according to the present disclosure is equally well suited for use in onshore operations and vice-versa. Further, unless otherwise noted, even though a Figure may depict a cased hole, it should be understood by those skilled in the art that the apparatus according to the present disclosure is equally well suited for use in open hole operations.

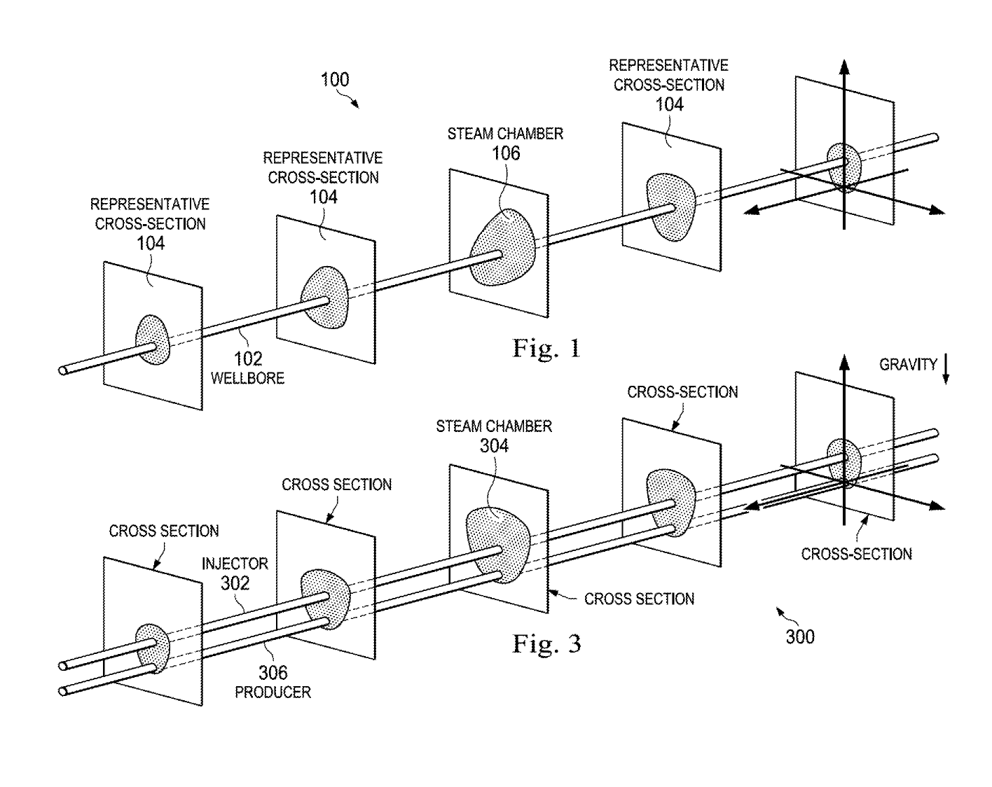

Illustrative embodiments and related methods of the present disclosure are described below in reference to FIGS. 1-8 as they might be employed for accurate modeling of near-field formation in wellbore simulations. Such embodiments and related methods may be practiced, for example, using a computer system as described herein. Other features and advantages of the disclosed embodiments will be or will become apparent to one of ordinary skill in the art upon examination of the following figures and detailed description. It is intended that all such additional features and advantages be included within the scope of the disclosed embodiments. Further, the illustrated figures are only exemplary and are not intended to assert or imply any limitation with regard to the environment, architecture, design, or process in which different embodiments may be implemented.

Embodiments of the present disclosure relate to a method for substantially improving functionality of a wellbore simulator by inline using a detailed multi-physics simulator to rigorously model transient thermal and flow fields in a near-wellbore region. FIG. 1 illustrates an example view 100 of modeling a flow inside a wellbore 102, according to certain embodiments of the present disclosure. In one or more embodiments, the simulation in the near-wellbore domain may be solved either as a sequence of two-dimensional (2D) applications or a three-dimensional (3D) application in a narrow volume next to the wellbore 102. Thus, the method presented herein is based on splitting a transient 3D solution of finding heat and mass transfer parameters in the wellbore 102 and near-wellbore region into an approach that couples modeling of flow inside the wellbore 102 with several transient 2D solutions in the vicinity to the wellbore (e.g., in the cross-sections 104, as illustrated in FIG. 1). Alternatively, the approach presented herein may couple modeling of flow inside the wellbore 102 and a 3D solution in a narrow domain (e.g., domain 106 in FIG. 1) next to the wellbore 102.

For modeling the flow inside the wellbore, advanced wellbore simulators can be employed, chosen according to the character of the application. For example, a specific wellbore simulator can be used to address the completion design application. For simulations in the near-wellbore domain, either a detailed commercially available multi-physics solver can be utilized or a home-made specialized multi-physics solver can be applied. In one or more embodiments where the application is substantially 3D on the scale of near-wellbore dimension (e.g., meters to tens of meters), a 3D version of the multi-physics solver can be employed, which may provide accuracy at the expense of a longer simulation time.

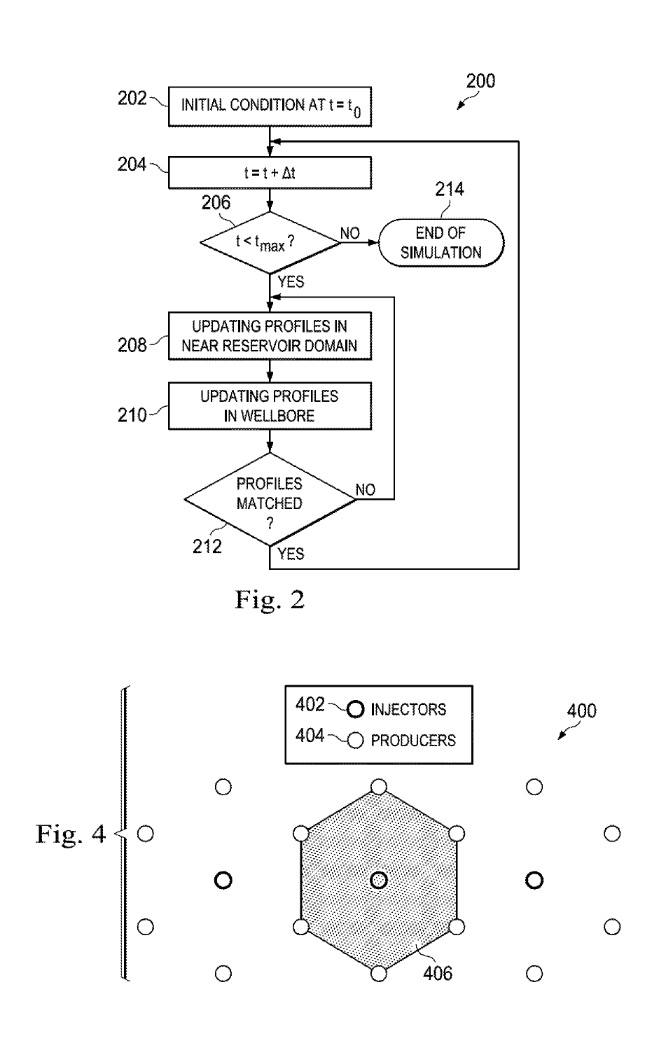

Certain embodiments of the present disclosure relate to a workflow for matching of two solvers (e.g., the wellbore simulator and the multi-physics solver). The matching can be made iteratively at every time step. FIG. 2 illustrates an example flowchart (workflow) 200 of a simulation process of coupling wellbore and reservoir (e.g., near-wellbore) simulations, according to certain embodiments of the present disclosure. At block 202, initial and boundary conditions may be set at a time instant t=t₀. At block 204, the time t may be increased by a small increment Δt. If time t exceeds a pre-defined maximum simulation time tₘₐₓ (e.g., determined at decision block 206 in FIG. 2), then the simulation process stops at block 214. Otherwise (i.e., if time t does not exceed the pre-defined maximum simulation time tₘₐₓ), profiles of heat and mass fluxes between the reservoir formation and the wellbore may be calculated, at block 208, using a multi-physics solver. Δt block 210, the flow and temperature profiles in the wellbore may be calculated for time t using the wellbore solver. If the change of pressure and temperature along the wellbore is not small enough (e.g., the profiles of heat and mass fluxes between the reservoir formation and the wellbore do not match with flow and temperature profiles in the wellbore, as determined at decision block 212 in FIG. 2), simulation operations in blocks 208 and 210 are repeated. Otherwise, the convergence is reached, and the simulation process 200 may continue by incrementing the time period at block 204.

Several examples on how the presented iterative simulation process can be applied for modeling completions and productions involving complex near-wellbore geometries are described in the present disclosure. For certain embodiments, the iterative workflow 200 of coupling wellbore and reservoir simulations illustrated in FIG. 2 may be applied in the steam assisted gravity drainage (SAGD) process. FIG. 3 illustrates an example simulation scheme 300 for the SAGD process, according to certain embodiments of the present disclosure. The SAGD process may involve supplying a steam into a formation by an injector well 302, forming of a hot steam chamber 304 around the injector well 302, and collecting oil with reduced viscosity by a producer well 306. For the embodiments related to the SAGD process illustrated in FIG. 3, simulations may follow the iterative workflow 200 illustrated in FIG. 2, wherein the wellbore solver may be utilized for two horizontal wellbores at each time step, i.e., for the injector wellbore 302 and the producer wellbore 306. In an embodiment, a distance between the injector wellbore 302 and the producer wellbore 306 may be in order of several meters. In one or more embodiments, the multi-physics solver may be applied to calculate evolution of profiles of steam, water and oil, as well as phase transition in the near reservoir domain. For certain embodiments, an output result of the performed simulations may be related to an oil production and/or a water production as a function of time.

For certain embodiments, the iterative simulation workflow 200 of coupling wellbore and reservoir simulations illustrated in FIG. 2 may be applied for the steam/liquid/gas flooding process. FIG. 4 illustrates an example of a steam flooding pattern 400 of injectors (e.g., injector wells 402) and producers (e.g., producer wells 404), according to certain embodiments of the present disclosure. The steam/liquid/gas flooding process may involve repeating patterns of vertical injection wells 402 and production wells 404, as illustrated in FIG. 4. In one or more embodiments, the wellbore simulator may be used for the wells (e.g., injector wells 402 and producer wells 404 in FIG. 4). For some embodiments, the parameters of the reservoir formation can be particularly effectively found by applying the multi-physics simulator to a cell including injector well 402 and several neighboring production wells 404 (e.g., cell 406 illustrated in FIG. 4), if the pattern is periodically repeated, as illustrated in FIG. 4.

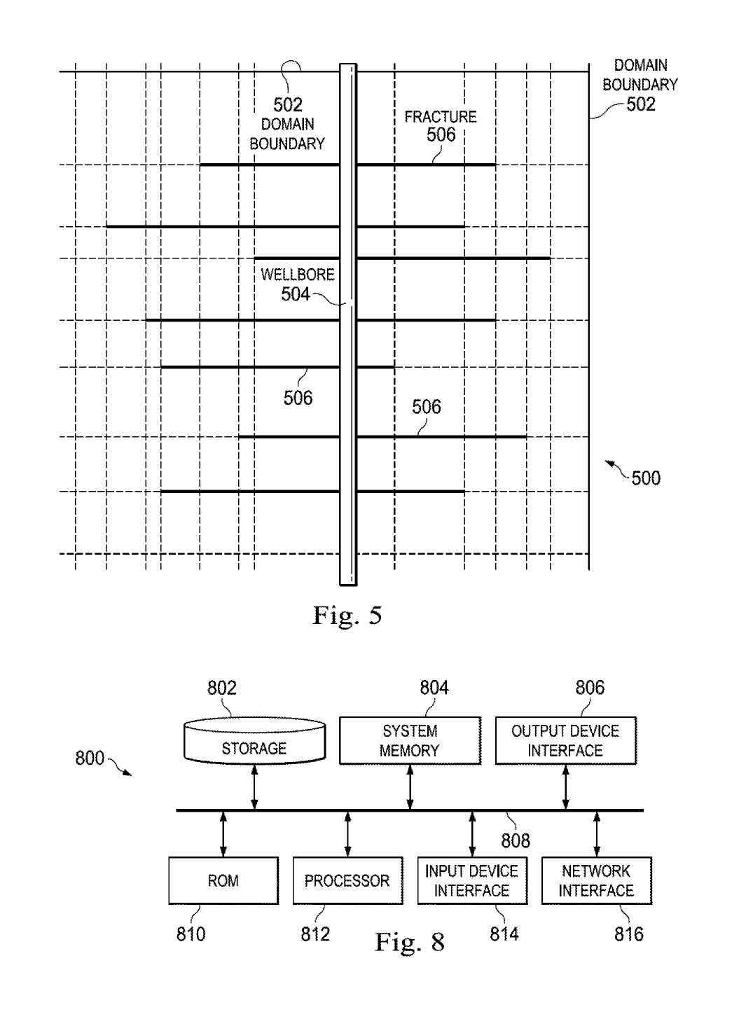

For certain embodiments, the iterative simulation workflow 200 of coupling wellbore and reservoir simulations illustrated in FIG. 2 may be applied for the production process from a fracture-stimulated reservoir. FIG. 5 illustrates an example schematic model 500 of the production process from a fracture-stimulated reservoir, according to certain embodiments of the present disclosure. FIG. 5 illustrates a schematic of the domain 502 for calculating a production rate from the fracture-stimulated reservoir. In many practical cases, most of hydrocarbon/water flow parameters can be considered two-dimensional in the plane parallel to the wellbore (e.g., wellbore 504 in FIG. 5) and perpendicular to the fractures (e.g., fractures 506 in FIG. 5). Δt every time step, the corresponding profiles may be updated using the multi-physics solver. In one or more embodiments, if the pressure drop in the fractures 506 is negligible, the general solution workflow 200 illustrated in FIG. 2 can be directly applied. In one or more other embodiments, if the pressure drop in the fractures 506 is not negligible and needs to be taken into account, solution of the lubrication equations for the fracture flows can be performed by the same multi-physics solver at each time step. Many complications, such as presence of the condensates, can be predicted accurately with the presented approach.

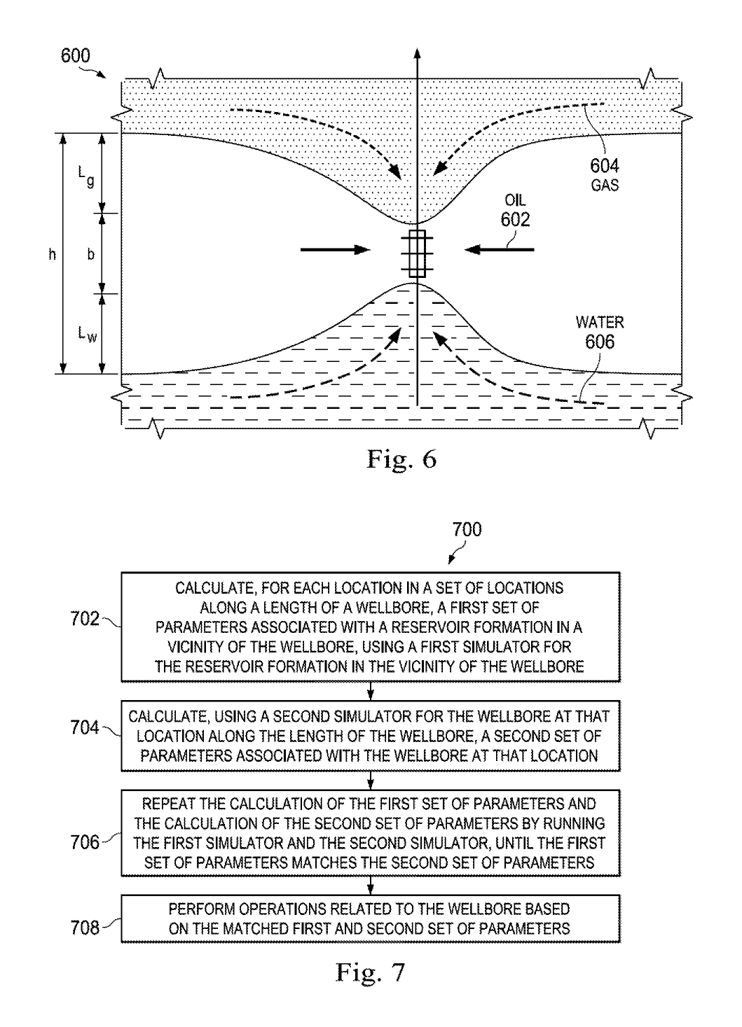

For certain embodiments, the iterative simulation workflow 200 of coupling wellbore and reservoir simulations illustrated in FIG. 2 may be applied for the gas/water coning application. FIG. 6 illustrates an example schematic view 600 of the gas and water coning application, according to certain embodiments of the present disclosure. When a horizontal wellbore having a flow of oil 602 is situated between the layers of gas 604 and water 606 (aquifer), the danger of well flooding becomes imminent, unless the pressure drop along the wellbore is controlled. Simulations can be performed in this particular case that follow all the operations of the iterative workflow 200 illustrated in FIG. 2, combining the wellbore simulations with multi-phase near reservoir simulations at each time step.

Discussion of an illustrative method of the present disclosure will now be made with reference to FIG. 7, which is a flow chart 700 of a method for modeling near-field formation in wellbore simulations by coupling wellbore and reservoir simulators, according to certain embodiments of the present disclosure. The method begins at 702 by calculating, for each location in a set of locations along a length of a wellbore, a first set of parameters (e.g., a temperature distribution, a pressure distribution, a flow distribution in a near-wellbore domain) associated with a reservoir formation in a vicinity of the wellbore, using a first simulator (e.g., a two-dimensional version of a multi-physics solver) for the reservoir formation in the vicinity of the wellbore. Δt 704, using a second simulator (e.g., a two-dimensional wellbore solver) for the wellbore at that location along the length of the wellbore, a second set of parameters (a temperature distribution, a pressure distribution, a flow distribution inside the wellbore) associated with the wellbore at that location may be calculated. Δt 706, the calculation of the first set of parameters and the calculation of the second set of parameters may be repeated by running the first simulator and the second simulator, until the first set of parameters matches the second set of parameters. Δt 708, operations related to the wellbore (e.g., completion, production) may be performed based on the matched first and second set of parameters. In one or more embodiments, the matching between the first set of parameters and the second set of parameters may be performed iteratively at every time step, as illustrated by the iterative method 200 illustrated in FIG. 2.

FIG. 8 is a block diagram of an illustrative computing system 800 in which embodiments of the present disclosure may be implemented adapted for modeling near-field formation in wellbore simulations. For example, the operations of framework 200 from FIG. 2 and the operations of method 700 of FIG. 7, as described above, may be implemented using the computing system 800. The computing system 800 can be a computer, phone, personal digital assistant (PDA), or any other type of electronic device. Such an electronic device includes various types of computer readable media and interfaces for various other types of computer readable media. As shown in FIG. 8, the computing system 800 includes a permanent storage device 802, a system memory 804, an output device interface 806, a system communications bus 808, a read-only memory (ROM) 810, processing unit(s) 812, an input device interface 814, and a network interface 816.

The bus 808 collectively represents all system, peripheral, and chipset buses that communicatively connect the numerous internal devices of the computing system 800. For instance, the bus 808 communicatively connects the processing unit(s) 812 with the ROM 810, the system memory 804, and the permanent storage device 802.

From these various memory units, the processing unit(s) 812 retrieves instructions to execute and data to process in order to execute the processes of the subject disclosure. The processing unit(s) can be a single processor or a multi-core processor in different implementations.

The ROM 810 stores static data and instructions that are needed by the processing unit(s) 812 and other modules of the computing system 800. The permanent storage device 802, on the other hand, is a read-and-write memory device. This device is a non-volatile memory unit that stores instructions and data even when the computing system 800 is off. Some implementations of the subject disclosure use a mass-storage device (such as a magnetic or optical disk and its corresponding disk drive) as the permanent storage device 802.

Other implementations use a removable storage device (such as a floppy disk, flash drive, and its corresponding disk drive) as the permanent storage device 802. Like the permanent storage device 802, the system memory 804 is a read-and-write memory device. However, unlike the storage device 802, the system memory 804 is a volatile read-and-write memory, such a random access memory. The system memory 804 stores some of the instructions and data that the processor needs at runtime. In some implementations, the processes of the subject disclosure are stored in the system memory 804, the permanent storage device 802, and/or the ROM 810. For example, the various memory units include instructions for computer aided pipe string design based on existing string designs in accordance with some implementations. From these various memory units, the processing unit(s) 812 retrieves instructions to execute and data to process in order to execute the processes of some implementations.

The bus 808 also connects to the input and output device interfaces 814 and 806. The input device interface 814 enables the user to communicate information and select commands to the computing system 800. Input devices used with the input device interface 814 include, for example, alphanumeric, QWERTY, or T9 keyboards, microphones, and pointing devices (also called “cursor control devices”). The output device interfaces 806 enables, for example, the display of images generated by the computing system 800. Output devices used with the output device interface 806 include, for example, printers and display devices, such as cathode ray tubes (CRT) or liquid crystal displays (LCD). Some implementations include devices such as a touchscreen that functions as both input and output devices. It should be appreciated that embodiments of the present disclosure may be implemented using a computer including any of various types of input and output devices for enabling interaction with a user. Such interaction may include feedback to or from the user in different forms of sensory feedback including, but is not limited to, visual feedback, auditory feedback, or tactile feedback. Further, input from the user can be received in any form including, but not limited to, acoustic, speech, or tactile input. Additionally, interaction with the user may include transmitting and receiving different types of information, e.g., in the form of documents, to and from the user via the above-described interfaces.

Also, as shown in FIG. 8, the bus 808 also couples the computing system 800 to a public or private network (not shown) or combination of networks through a network interface 816. Such a network may include, for example, a local area network (“LAN”), such as an Intranet, or a wide area network (“WAN”), such as the Internet. Any or all components of the computing system 800 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself. Accordingly, the operations of framework 200 from FIG. 2 and the operations of method 700 of FIG. 7, as described above, may be implemented using the computing system 800 or any computer system having processing circuitry or a computer program product including instructions stored therein, which, when executed by at least one processor, causes the processor to perform functions relating to these methods.

As used in this specification and any claims of this application, the terms “computer”, “server”, “processor”, and “memory” all refer to electronic or other technological devices. These terms exclude people or groups of people. As used herein, the terms “computer readable medium” and “computer readable media” refer generally to tangible, physical, and non-transitory electronic storage mediums that store information in a form that is readable by a computer.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs implemented on the respective computers and having a client-server relationship to each other. In some embodiments, a server transmits data (e.g., a web page) to a client device (e.g., for purposes of displaying data to and receiving user input from a user interacting with the client device). Data generated at the client device (e.g., a result of the user interaction) can be received from the client device at the server.

It is understood that any specific order or hierarchy of operations in the processes disclosed is an illustration of exemplary approaches. Based upon design preferences, it is understood that the specific order or hierarchy of operations in the processes may be rearranged, or that all illustrated operations be performed. Some of the operations may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Furthermore, the illustrative methods described herein may be implemented by a system including processing circuitry or a computer program product including instructions which, when executed by at least one processor, causes the processor to perform any of the methods described herein.

A computer-implemented method for coupling simulations has been described in the present disclosure and may generally include: calculating, for each location in a set of locations along a length of a wellbore, a first set of parameters associated with a reservoir formation in a vicinity of the wellbore, using a first simulator for the reservoir formation in the vicinity of the wellbore; calculating, using a second simulator for the wellbore at that location along the length of the wellbore, a second set of parameters associated with the wellbore at that location; repeating the calculation of the first set of parameters and the calculation of the second set of parameters by running the first simulator and the second simulator, until the first set of parameters matches the second set of parameters; and performing operations related to the wellbore based on the matched first and second set of parameters. Further, a computer-readable storage medium with instructions stored therein has been described, instructions when executed by a computer cause the computer to perform a plurality of functions, including functions to: calculate, for each location in a set of locations along a length of a wellbore, a first set of parameters associated with a reservoir formation in a vicinity of the wellbore, using a first simulator for the reservoir formation in the vicinity of the wellbore; calculate, using a second simulator for the wellbore at that location along the length of the wellbore, a second set of parameters associated with the wellbore at that location; repeat the calculation of the first set of parameters and the calculation of the second set of parameters by running the first simulator and the second simulator, until the first set of parameters matches the second set of parameters; and generate an order for performing operations related to the wellbore based on the matched first and second set of parameters.

For the foregoing embodiments, the method or functions may include any one of the following operations, alone or in combination with each other: matching between the first set of parameters and the second set of parameters is performed iteratively at every time step; the instructions further perform functions to match the first set of parameters with the second set of parameters by iteratively running the first simulator and the second simulator at every time step.

The first set of parameters comprises at least one of: a temperature distribution, a pressure distribution, or a flow distribution associated with the reservoir formation in the vicinity of the wellbore for that location along the length of the wellbore; The second set of parameters comprises at least one of: a temperature distribution, a pressure distribution, or a flow distribution in the wellbore at that location; The first simulator for the reservoir formation in the vicinity of the wellbore comprises a two-dimensional version of a multi-physics solver; The first simulator for the reservoir formation in the vicinity of the wellbore comprises a three-dimensional version of a multi-physics solver, and the vicinity of the wellbore comprises a volume of a defined size around the wellbore at that location; The second simulator for the wellbore comprises a two-dimensional wellbore solver.

Likewise, a system for coupling simulations has been described and include at least one processor and a memory coupled to the processor having instructions stored therein, which when executed by the processor, cause the processor to perform functions, including functions to: calculate, for each location in a set of locations along a length of a wellbore, a first set of parameters associated with a reservoir formation in a vicinity of the wellbore, using a first simulator for the reservoir formation in the vicinity of the wellbore; calculate, using a second simulator for the wellbore at that location along the length of the wellbore, a second set of parameters associated with the wellbore at that location; repeat the calculation of the first set of parameters and the calculation of the second set of parameters by running the first simulator and the second simulator, until the first set of parameters matches the second set of parameters; and generate an order for performing operations related to the wellbore based on the matched first and second set of parameters.

For any of the foregoing embodiments, the system may include any one of the following elements, alone or in combination with each other: the functions performed by the processor include functions to match the first set of parameters with the second set of parameters by iteratively running the first simulator and the second simulator at every time step.

Embodiments of the present disclosure relate to an iterative simulation process (e.g., the iterative workflow 200 illustrated in FIG. 2) for rigorous simulation of heat and mass transfer between a reservoir and a wellbore in a variety of completion and production operations, using bilaterally coupled wellbore simulator and multi-physics solver. In one or more embodiments, solver/simulators that are being applied can be either commercially (off-the-shelf) available or custom-made (home-made). The present disclosure further describes specific implementations of the simulation workflow.

Implementation of the workflow presented in this disclosure can create an efficient simulator for a variety of applications, including, but not restricted to SAGD, steam and water flooding, production from fractured reservoirs, detailed coning prediction, perforated wellbore productivity, and the like. The workflow presented in this disclosure may significantly reduce time needed to run simulations and may allow performing effective and inexpensive heat and mass transfer simulations using an augmented wellbore simulator.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

While specific details about the above embodiments have been described, the above hardware and software descriptions are intended merely as example embodiments and are not intended to limit the structure or implementation of the disclosed embodiments. For instance, although many other internal components of computer system 800 are not shown, those of ordinary skill in the art will appreciate that such components and their interconnection are well known.

In addition, certain aspects of the disclosed embodiments, as outlined above, may be embodied in software that is executed using one or more processing units/components. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives, optical or magnetic disks, and the like, which may provide storage at any time for the software programming.

Additionally, the flowchart and block diagrams in the figures illustrate the architecture, functionality, and operation of possible implementations of systems, methods and computer program products according to various embodiments of the present disclosure. It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The above specific example embodiments are not intended to limit the scope of the claims. The example embodiments may be modified by including, excluding, or combining one or more features or functions described in the disclosure.

What is claimed is:

1. A computer-implemented method for coupling simulations, the method comprising:
calculating, for each location in a set of locations along a length of a wellbore, a first set of parameters associated with a reservoir formation in a vicinity of the wellbore, using a first simulator for the reservoir formation in the vicinity of the wellbore;
calculating, using a second simulator for the wellbore at that location along the length of the wellbore, a second set of parameters associated with the wellbore at that location;
repeating the calculation of the first set of parameters and the calculation of the second set of parameters by running the first simulator and the second simulator, until the first set of parameters matches the second set of parameters; and
performing operations related to the wellbore based on the matched first and second set of parameters.

2. The method of claim 1, wherein the first set of parameters comprises at least one of: a temperature distribution, a pressure distribution, or a flow distribution associated with the reservoir formation in the vicinity of the wellbore for that location along the length of the wellbore.

3. The method of claim 1, wherein the second set of parameters comprises at least one of: a temperature distribution, a pressure distribution, or a flow distribution in the wellbore at that location.

4. The method of claim 1, wherein the first simulator for the reservoir formation in the vicinity of the wellbore comprises a two-dimensional version of a multi-physics solver.

5. The method of claim 1, wherein:
the first simulator for the reservoir formation in the vicinity of the wellbore comprises a three-dimensional version of a multi-physics solver, and
the vicinity of the wellbore comprises a volume of a defined size around the wellbore at that location.

6. The method of claim 1, wherein the second simulator for the wellbore comprises a two-dimensional wellbore solver.

7. The method of claim 1, wherein the matching between the first set of parameters and the second set of parameters is performed iteratively at every time step.

8. A system for coupling simulations, the method comprising:
at least one processor; and
a memory coupled to the processor having instructions stored therein, which when executed by the processor, cause the processor to perform functions, including functions to:
calculate, for each location in a set of locations along a length of a wellbore, a first set of parameters associated with a reservoir formation in a vicinity of the wellbore, using a first simulator for the reservoir formation in the vicinity of the wellbore;
calculate, using a second simulator for the wellbore at that location along the length of the wellbore, a second set of parameters associated with the wellbore at that location;
repeat the calculation of the first set of parameters and the calculation of the second set of parameters by running the first simulator and the second simulator, until the first set of parameters matches the second set of parameters; and
generate an order for performing operations related to the wellbore based on the matched first and second set of parameters.

9. The system of claim 8, wherein the first set of parameters comprises at least one of: a temperature distribution, a pressure distribution, or a flow distribution associated with the reservoir formation in the vicinity of the wellbore for that location along the length of the wellbore.

10. The system of claim 8, wherein the second set of parameters comprises at least one of: a temperature distribution, a pressure distribution, or a flow distribution in the wellbore at that location.

11. The system of claim 8, wherein the first simulator for the reservoir formation in the vicinity of the wellbore comprises a two-dimensional version of a multi-physics solver.

12. The system of claim 8, wherein:
the first simulator for the reservoir formation in the vicinity of the wellbore comprises a three-dimensional version of a multi-physics solver, and
the vicinity of the wellbore comprises a volume of a defined size around the wellbore at that location.

13. The system of claim 8, wherein the second simulator for the wellbore comprises a two-dimensional wellbore solver.

14. The system of claim 8, wherein the functions performed by the processor include functions to match the first set of parameters with the second set of parameters by iteratively running the first simulator and the second simulator at every time step.

15. A computer-readable storage medium having instructions stored therein, which when executed by a computer cause the computer to perform a plurality of functions, including functions to:
calculate, for each location in a set of locations along a length of a wellbore, a first set of parameters associated with a reservoir formation in a vicinity of the wellbore, using a first simulator for the reservoir formation in the vicinity of the wellbore;
calculate, using a second simulator for the wellbore at that location along the length of the wellbore, a second set of parameters associated with the wellbore at that location;
repeat the calculation of the first set of parameters and the calculation of the second set of parameters by running the first simulator and the second simulator, until the first set of parameters matches the second set of parameters; and
generate an order for performing operations related to the wellbore based on the matched first and second set of parameters.

16. The computer-readable storage medium of claim 15, wherein the instructions further perform functions to match the first set of parameters with the second set of parameters by iteratively running the first simulator and the second simulator at every time step.
